(19) United States
(12) Patent Application Publication
(10) Pub. No.: US 2014/0183367 A1
(43) Pub. Date: Jul. 3, 2014

(54) DISPLAY DEVICE

(71) Applicant: PANASONIC CORPORATION, Osaka (JP)

(72) Inventor: Takashi KUDO, Osaka (JP)

(73) Assignee: PANASONIC CORPORATION, Osaka (JP)

(21) Appl. No.: 14/103,690

(22) Filed: Dec. 11, 2013

(30) Foreign Application Priority Data
Dec. 27, 2012 (JP) 2012-284196
Oct. 25, 2013 (JP) 2013-222282

(51) Int. Cl. F21V 8/00; G01J 1/04

(52) U.S. Cl. CPC G02B 6/0031; G01J 1/0407
USPC 250/353; 362/609; 250/504 R; 250/216

(57) ABSTRACT

This technique provides a display device including an optical unit that is located at a lower section of a housing accommodating a display panel. The optical unit has a unit main body that includes a plurality of light guide members integrally provided at a base, and a case accommodating the unit main body. The light guide members of the unit main body include a receiving light guide member that has an incident surface exposed to a front surface of the housing, an emitting surface for emitting light to a light receiving sensor, and a reflective surface provided between the incident surface and the emitting surface, and an emitting light guide member for guiding light from a light emitting diode to the front surface of the housing.

### BACKGROUND OF THE INVENTION

1. Field of the Invention

The present technique relates to a thin display device such as a plasma display or a liquid crystal display.

2. Description of the Related Art

In recent years, outer design of a thin display device such as a plasma display or a liquid crystal display has been developed by further reducing the thickness in a depth direction of the display device, by reducing the width of a frame surrounding a display panel, in other words, by adopting a narrow picture-frame, or the like (see Unexamined Japanese Patent Publication No. 2005-117177).

### SUMMARY OF THE INVENTION

The present technique provides a display device including an optical unit that is located at a lower section of a housing accommodating a display panel. The optical unit has a unit main body that includes a plurality of light guide members integrally provided at a base, and a case accommodating the unit main body. The light guide members in the unit main body include a receiving light guide member that has an incident surface exposed from a front surface of the housing, an emitting surface for emitting light to a light receiving sensor, and a reflective surface provided between the incident surface and the emitting surface.

### BRIEF DESCRIPTION OF DRAWINGS

FIG. 1 is a perspective view from the front, of a display device according to an exemplary embodiment of the present technique;

FIG. 2 is a perspective view from the rear, of the display device;

FIG. 3 is a sectional view of the display device, showing the internal structure of a lower section provided with an optical unit;

FIG. 4 is an enlarged perspective view of the optical unit at portion A indicated in FIG. 1;

FIG. 5 is a plan view from inside, of a front frame in a state where the optical unit is removed;

FIG. 6 is a perspective view of the optical unit included in the display device according to the exemplary embodiment of the present technique;

FIG. 7 is a sectional view taken along line 7-7 indicated in FIG. 6, showing the configuration of the optical unit;

FIG. 8 is a perspective view showing the internal structure of the optical unit in a state where a cover is removed;

FIG. 9 is a perspective view from above, of a unit main body in the optical unit;

FIG. 10 is a perspective view from below, of the unit main body in the optical unit;

FIG. 11 is a perspective view of a case of the optical unit; and

FIG. 12 is a sectional view of an exemplary reinforcing frame in the display device according to the present technique.

### DETAILED DESCRIPTION OF THE INVENTION

A display device according to an exemplary embodiment of the present technique is described below with reference to the drawings. It is noted that excessive details may not be described. For example, details of well known matters or repetitious description of substantially same configurations may not be provided in some cases. This is for avoiding unnecessary long description and for allowing those skilled in the art to easily understand the present technique.

The inventor provides the accompanying drawings and the following description in order to help those skilled in the art to sufficiently understand the present technique, and does not intend to limit the subject matter recited in claims by means of these drawings or the description.

### (Entire Configuration of Display Device)

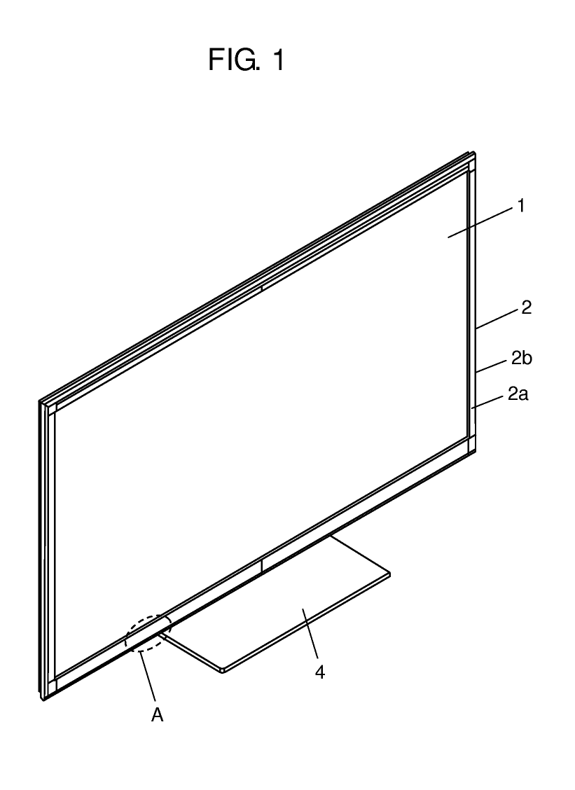

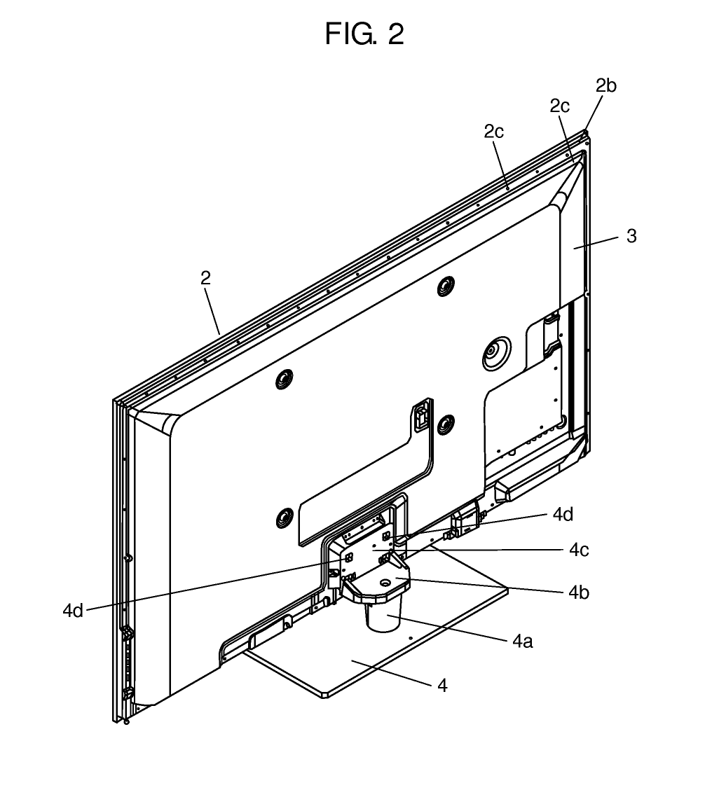

FIG. 1 is a perspective view from the front, of the display device according to the exemplary embodiment of the present technique. FIG. 2 is a perspective view from the rear, of the display device.

As shown in FIGS. 1 and 2, the display device includes display panel 1 such as a plasma display panel or a liquid crystal display panel, and a housing that has front frame 2 made of metal or resin and metal rear cover 3 and accommodates display panel 1. Front frame 2 covers a non-display region in the front surface and the side surfaces of display panel 1. Front frame 2 according to the present exemplary embodiment has resin portion 2a and metal portion 2b. Metal portion 2b covers the side surfaces and the periphery of the front surface of display panel 1. Resin portion 2a is fixed to metal portion 2b by bonding or screwing at the front surface of display panel 1 so as to cover the non-display region of display panel 1. Metal portion 2b has side surfaces provided with screw holes 2c that are used for fixing front frame 2 to a chassis of display panel 1. Metal portion 2b is divided into four frame members at left, upper, right, and lower sections. These members are coupled at corners by welding or the like.

The display device has stand 4 that is retained by the chassis of display panel 1 and rear cover 3. The display device is set vertically by stand 4. Stand 4 has post 4a, pedestal 4b provided on post 4a, mount portion 4c attached to the rear surface of rear cover 3, and screw holes 4d provided in mount portion 4c.

The display device is provided, at rear cover 3, with various input terminals including an antenna input terminal, a LAN terminal, and an HDMI (registered trademark) terminal.

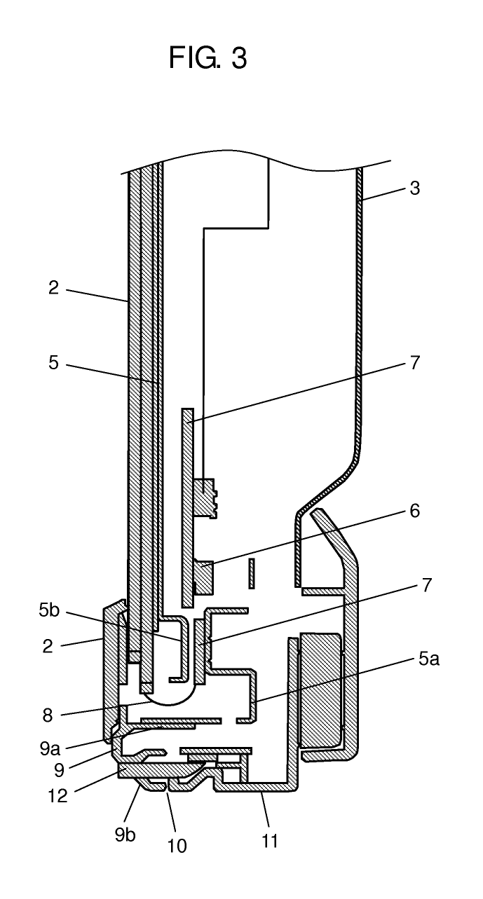

FIG. 3 is a sectional view of the display device, showing the internal structure of a lower section provided with an optical unit. As shown in FIG. 3, display panel 1 is retained by chassis 5 and is accommodated in the housing that has front frame 2 and rear cover 3. Chassis 5 is provided with circuit board 7 that has drive circuit 6 for driving to cause display panel 1 to display images. Display panel 1 is electrically connected with circuit board 7 by way of flexible wiring board 8. Circuit board 7 connected with flexible wiring board 8 is mounted at reinforcing frame 5a that is attached to chassis 5. In FIG. 3, chassis 5 is provided, at the lower end, with mount piece 5b to which reinforcing frame 5a is attached.

Front frame 2 of the housing is provided, at the lower section, with metal frame 9 in which optical unit 10 is located. Optical unit 10 is configured such that components of optical unit 10 are located in case 11. Metal frame 9 is attached to chassis 5 by means of mount piece 9a and has an end, which is located so as to butt against case 11 of optical unit 10 and has slanting surface 9b slanted in a depth direction. Optical unit 10 is to be described later. FIG. 3 depicts only receiving light guide member 12 in optical unit 10.

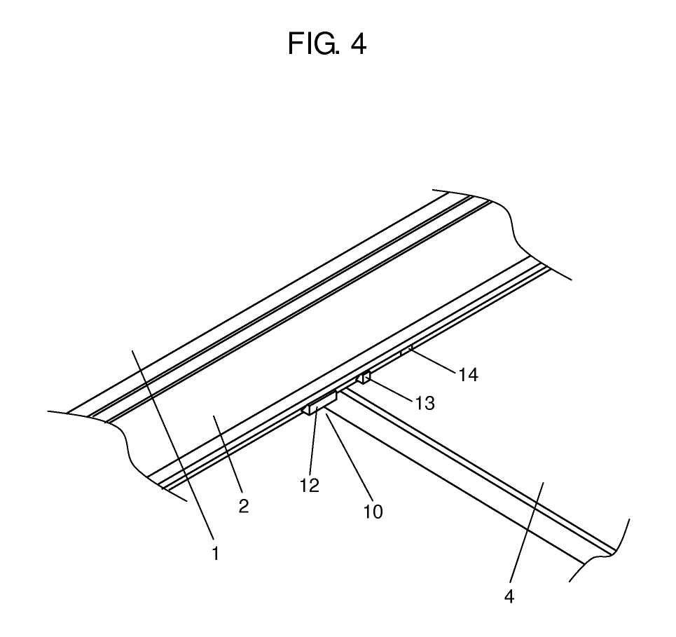

FIG. 4 is an enlarged perspective view of the optical unit at portion A indicated in FIG. 1. As shown in FIG. 4, optical unit 10 is provided with receiving light guide members 12 and 13 and emitting light guide member 14 that are exposed from the front surface of the housing of the display device. Receiving light guide member 12 is made of a light permeable resin material and receives infrared light from an infrared remote controller. Receiving light guide member 13 is made of a light permeable resin material and receives ambient light in the environment surrounding the display device. Emitting light guide member 14 is made of a light permeable resin material and guides light from a light emitting diode (LED) for indicating the operation state of the display device so as to indicate the operation state of the display device on the front surface of the display device.

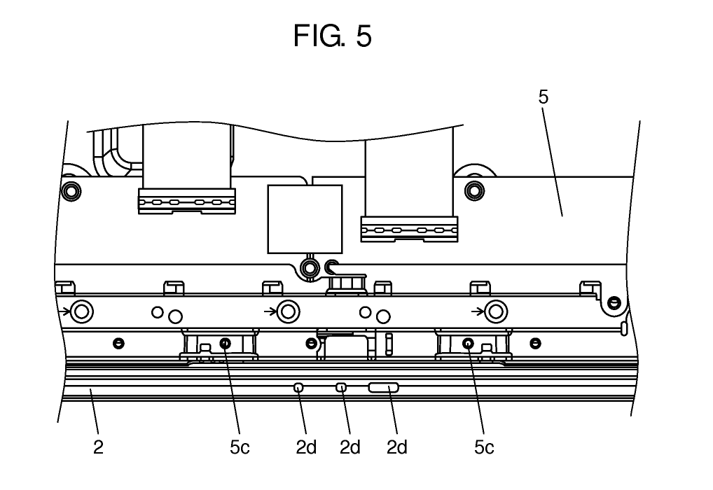

FIG. 5 is a plan view from inside, of the front frame in a state where the optical unit is removed. As shown in FIG. 5, front frame 2 has holes 2d that allow receiving light guide members 12 and 13 and emitting light guide member 14 in optical unit 10 to penetrate so as to be exposed to the front surface. Reinforcing frame 5a of chassis 5 has screw holes 5c that are used for attaching case 11 of optical unit 10.

### (Configuration of Optical Unit)

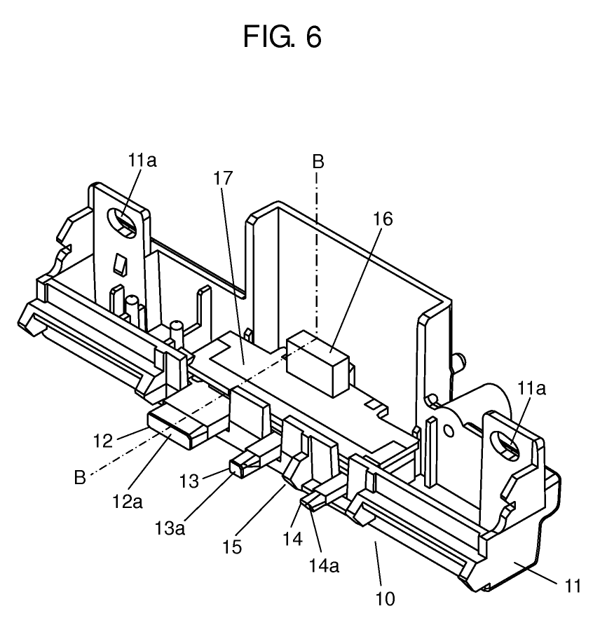

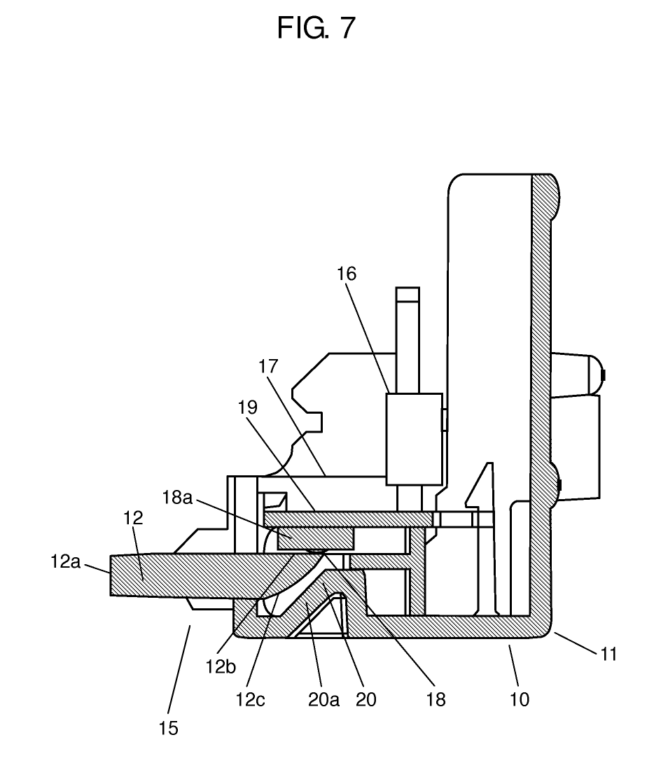

FIG. 6 is a perspective view of the optical unit included in the display device according to the exemplary embodiment of the present technique. FIG. 7 is a sectional view taken along line 7-7 indicated in FIG. 6, showing the configuration of the optical unit.

As shown in FIG. 6, optical unit 10 is configured such that unit main body 15 is located at case 11. Unit main body 15 has receiving light guide members 12 and 13 and emitting light guide member 14, each of which is made of a polycarbonate or acrylic resin material that has light permeability and a prism shape. Case 11 is a molded article of black or dark resin such as ABS resin, and has mount pieces 11a that are attached to reinforcing frame 5a of chassis 5. Unit main body 15 attached to case 11 is covered with cover 17 such that connector 16 used for connection with an external electric circuit is exposed.

Receiving light guide members 12 and 13 have front incident surfaces 12a and 13a, respectively, which are substantially parallel to the display surface of the display device. Emitting light guide member 14 has front emitting surface 14a that is slanted along slanting surface 9b of metal frame 9 that is located at the lower section of front frame 2. This is because receiving light guide members 12 and 13 receive infrared light and ambient light, respectively, and incident surfaces 12a and 13a are preferred to be substantially parallel to the display surface of the display device in view of light receiving sensitivity. Meanwhile, emitting light guide member 14 would stand out if it projects from front frame 2 and would not be preferred in view of the outer appearance design because emitting light guide member 14 guides LED light in red, blue, green, or the like and emits the guided light from emitting surface 14a.

As shown in FIG. 7, receiving light guide member 12 has incident surface 12a at the front surface, emitting surface 12b at the rear end surface, and reflective surface 12c between incident surface 12a and emitting surface 12b. Reflective surface 12c has a slanting surface that is curved outward, and infrared light entering from incident surface 12a is reflected in receiving light guide member 12 and is guided to reflective surface 12c. The infrared light guided to reflective surface 12c is reflected by reflective surface 12c and is emitted from emitting surface 12b.

There is provided light receiving sensor 18 in front of emitting surface 12b of receiving light guide member 12. Light receiving sensor 18 is mounted on board 18a and infrared light guided by receiving light guide member 12 enters light receiving sensor 18. Light receiving sensor 18 is mounted so as to be electrically connected to circuit board 19. Although not shown, there are mounted, on circuit board 19, a light receiving sensor such as an illuminance sensor for detecting ambient light entering from incident surface 13a of receiving light guide member 13, and an LED for emitting light in red, blue, green, or the like from emitting surface 14a of emitting light guide member 14. The light receiving sensor and the LED are electrically connected to each other. Circuit board 19 is electrically connected to the circuit board by way of connector 16. The circuit board is provided with a control circuit of the display device.

There is provided projection 20 at a position opposite to reflective surface 12c of receiving light guide member 12 on the bottom of case 11. Projection 20 has glossy reflective surface 20a that reflects incident light. Infrared light entering from incident surface 12a of receiving light guide member 12 is reflected by reflective surface 12c and is then emitted from emitting surface 12b to light receiving sensor 18, whereas part of the infrared light reaching reflective surface 12c leaks outside from reflective surface 12c. The infrared light leaked from reflective surface 12c is reflected by glossy reflective surface 20a provided on case 11, and re-enters receiving light guide member 12 from reflective surface 12c and its periphery. The infrared light reflected by reflective surface 20a and re-entering receiving light guide member 12 is to be emitted from emitting surface 12b toward light receiving sensor 18 along with the infrared light reflected by reflective surface 12c of receiving light guide member 12. The infrared light is leaked out of receiving light guide member 12 not only from reflective surface 12c but also from a portion from incident surface 12a to reflective surface 12c. Part of such leaking light is reflected by glossy reflective surface 20a and is re-reflected to the inside of receiving light guide member 12.

Reflective surface 12c of receiving light guide member 12 is preferably slanted by approximately 45 degrees from the receiving surface of light receiving sensor 18 and the axis of receiving light guide member 12. Preferably, reflective surface 20a is glossy and is substantially parallel to reflective surface 12c of receiving light guide member 12 and slanted by approximately 45 degrees from the receiving surface of light receiving sensor 18 and the axis of receiving light guide member 12. Moreover, reflective surface 12c of receiving light guide member 12 and reflective surface 20a are preferably located so as to have a substantially constant gap therebetween. Reflective surface 20a can have any one of various shapes, such as a shape having one or multiple linear slanting surfaces, a shape having a curved concave slanting surface, a shape having a curved slanting surface so as to correspond to reflective surface 12c of receiving light guide member 12, a fan shape when viewed from above, a shape obtained by combining any ones of the above.

Although depending on the state of use, when operating with use of the infrared remote controller, it is required to satisfy the following conditions:

1. operable from a position away by about 8 m when operating in front of the light receiving portion of the display device;

2. operable from a position away by about 6 m when operating in the area vertically ranging by 15 degrees from the light receiving portion of the display device; and

3. operable from a position away by about 3 m when operating in the area vertically ranging by ±30 degrees from the light receiving portion of the display device.

Proved by a test is that a property sufficiently satisfying these three conditions is achieved if there is provided glossy reflective surface 20a in addition to receiving light guide member 12 having reflective surface 12c as in the present technique.

Receiving light guide member 12 is typically processed by specular working by means of evaporation of a metal film or the like in order that receiving light guide member 12 totally reflects infrared light entering from incident surface 12a and reflective surface 12c has higher reflectivity. To the contrary, according to the present technique, reflective surface 20a is provided so as to reflect infrared light leaked from receiving light guide member 12. In this configuration, the required conditions are satisfied with no need for specially processing receiving light guide member 12. Reflective surface 20a according to the present exemplary embodiment is made glossy. Reflective surface 20a can be alternatively processed by specular working. Glossy reflective surface 20a can be formed simultaneously with molding case 11 of resin by making arrangement to a mold under processing conditions for resin molding. The cost in this case is smaller than the case of processing by specular working.

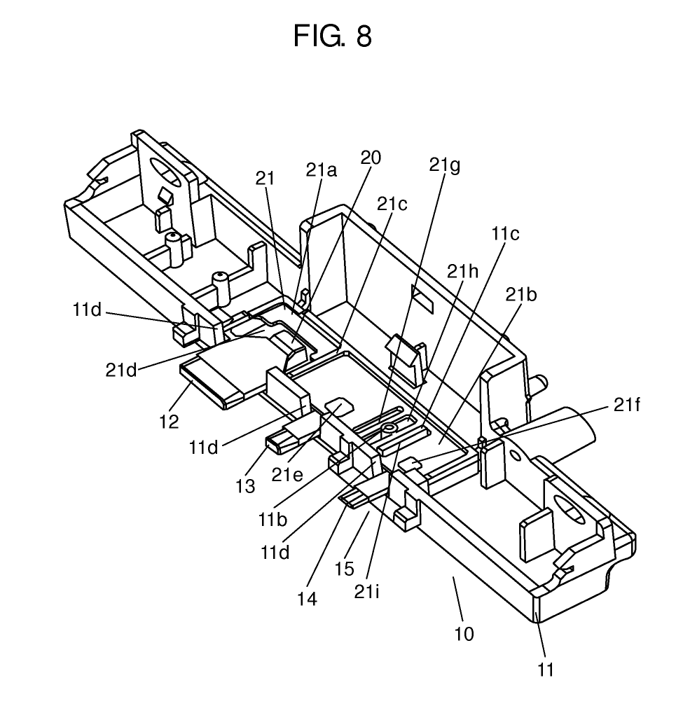

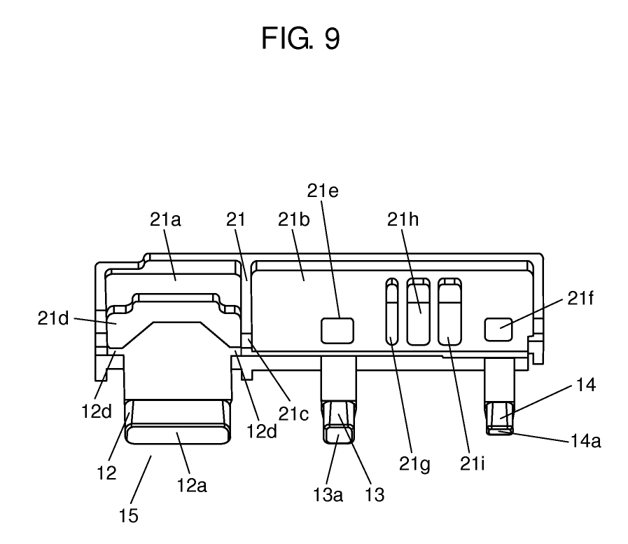

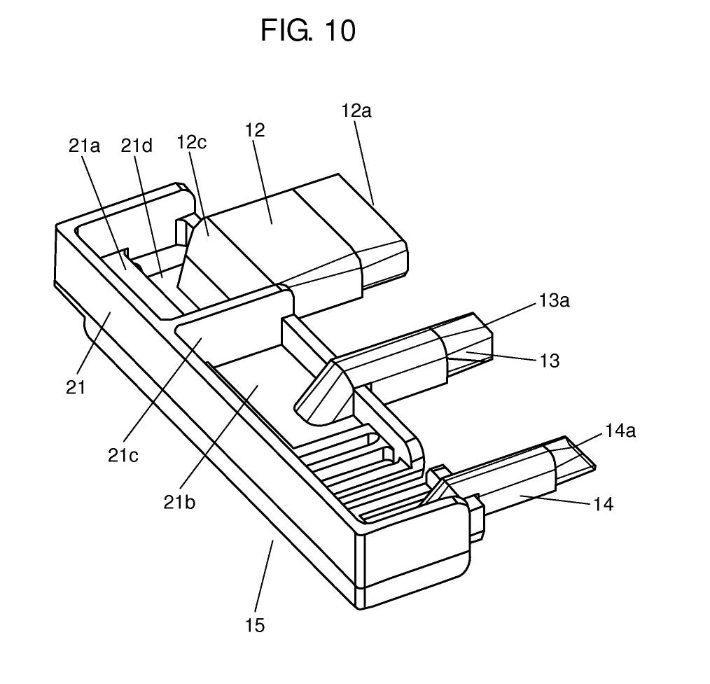

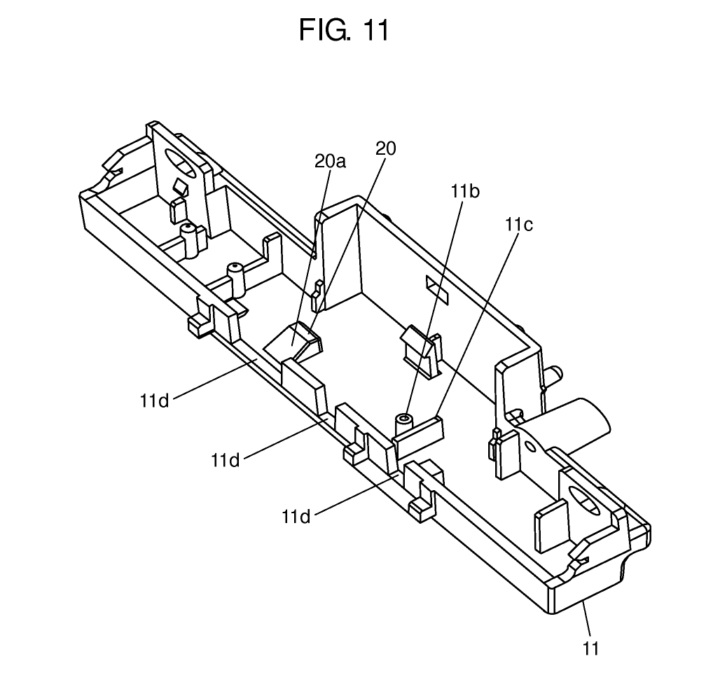

FIG. 8 is a perspective view showing the internal structure of the optical unit in a state where the cover is removed. FIG. 9 is a perspective view from above, of the unit main body in the optical unit. FIG. 10 is a perspective view from below, of the unit main body in the optical unit. FIG. 11 is a perspective view of the case of the optical unit.

As shown in FIGS. 8 to 10, unit main body 15 in optical unit 10 is formed by molding a polycarbonate or acrylic resin material that has light permeability. Receiving light guide members 12 and 13 and emitting light guide member 14 are formed integrally with common base 21 so as to project forward. Base 21 of unit main body 15 has first region 21a where receiving light guide member 12 is located and second region 21b where receiving light guide member 13 and emitting light guide member 14 are located. There is provided wall 21c between first region 21a and second region 21b so as to optically separate these regions. Optical separation means reduction in light propagation between first region 21a for receiving light guide member 12 and second region 21b for receiving light guide member 13 and emitting light guide member 14.

First region 21a of base 21 has opening 21d at a position corresponding to projection 20 having reflective surface 20a of case 11. Light receiving sensor 18 is located above opening 21d. In second region 21b of base 21, sensor mount portion 21e, where a board having a light receiving sensor such as the illuminance sensor is located, is provided near the emitting surface of receiving light guide member 13, whereas LED mount portion 21f, where a board having an LED is located, is provided near the incident surface of emitting light guide member 14. Furthermore, second region 21b of base 21 is provided with openings 21g, 21h, and 21i between receiving light guide member 13 and emitting light guide member 14.

As shown in FIG. 11, case 11 of optical unit 10 is provided with columnar projection 11b and dividing wall 11c in a flat plate shape at positions corresponding to openings 21h and 21i in base 21 of unit main body 15. Projection 11b of case 11 is inserted into opening 21h in base 21 of unit main body 15, so that unit main body 15 is positioned with respect to case 11. Dividing wall 11c of case 11 penetrates opening 21i in base 21 and projects to second region 21b of base 21, so as to serve as a wall that divides sensor mount portion 21e from LED mount portion 21f which are provided in second region 21b.

Case 11 is provided, in the front surface, with openings 11d in which receiving light guide members 12 and 13 and emitting light guide member 14 in unit main body 15 are located, respectively. As shown in FIG. 8, unit main body 15 is positioned with respect to case 11 and accommodated therein so that receiving light guide members 12 and 13 and emitting light guide member 14 project forward from openings 11d in case 11.

As shown in FIG. 9, in the present exemplary embodiment, receiving light guide member 12 for receiving infrared light from the infrared remote controller is integrally coupled to base 21 while connection piece 12d provided between incident surface 12a and reflective surface 12c is interposed therebetween. Connection piece 12d is provided so as to have an area smaller than those of other portions of receiving light guide member 12. This configuration prevents infrared light guided in receiving light guide member 12 from being propagated to a different light receiving sensor such as the illuminance sensor. It is also possible to prevent deterioration in light receiving sensitivity of light receiving sensor 18 by propagation of ambient light entering receiving light guide member 13 to receiving light guide member 12. Furthermore, base 21 has wall 21c between first region 21a for receiving light guide member 12 and second region 21b for receiving light guide member 13. This configuration can further reduce interaction between infrared light guided by receiving light guide member 12 and ambient light guided by receiving light guide member 13.

In the present exemplary embodiment, case 11 has dark color and dividing wall 11c is located between sensor mount portion 21e and LED mount portion 21f which are provided in second region 21b. This configuration can shield light propagated between the LED and the illuminance sensor. It is thus possible to prevent deterioration in sensitivity of the illuminance sensor due to propagation of light emitted from the LED to the illuminance sensor. In summary, unit main body 15 is provided with dividing walls 11c and 21c so as to prevent propagation of light guided by receiving light guide members 12 and 13 and emitting light guide member 14. This configuration prevents interaction among light guided by receiving light guide members 12 and 13 and emitting light guide member 14.

As described above, the display device according to the present technique includes optical unit 10 that is located at the lower section of the housing accommodating display panel 1. Optical unit 10 has unit main body 15 that includes the plurality of light guide members provided integrally with the base, and case 11 accommodating unit main body 15. The light guide members in unit main body 15 include receiving light guide members 12 and 13 each of which has the incident surface exposed to the front surface of the housing, the emitting surface for emitting light to the light receiving sensor, and the reflective surface provided between the incident surface and the emitting surface; and emitting light guide member 14 for guiding light from the light emitting diode to the front surface of the housing.

In this manner, the optical unit is configured by the unit main body having the light guide members and the case. The optical unit can be thus commonly applied to a display device of a different type. Furthermore, the optical unit is located at the lower section of the housing, so that the optical unit can be easily set to a display device having a narrow picture-frame.

Moreover, the display device according to the present technique includes optical unit 10 that is located at the lower section of the housing accommodating display panel 1. Optical unit 10 includes unit main body 15 having light guide member 12 that has incident surface 12a exposed to the front surface of the housing, emitting surface 12b for emitting light to light receiving sensor 18, and reflective surface 12c provided between incident surface 12a and emitting surface 12b, and case 11 accommodating unit main body 15. Case 11 has reflective surface 20a located at the position opposite to reflective surface 12c of light guide member 12, and reflective surface 20a reflects light from light guide member 12 toward light guide member 12.

The present technique achieves sufficient light receiving sensitivity with no use of any expensive light guide member processed by specular working by means of evaporation of a metal film or the like. Moreover, optical unit 10, which is configured by unit main body 15 including light guide member 12 and case 11, can be commonly applied to a display device of a different type. Furthermore, optical unit 10 is located at the lower section of the housing, so that optical unit 10 can be easily set to a display device having a narrow picture-frame.

The above exemplary embodiment exemplarily describes optical unit 10 that is provided with receiving light guide member 12 for receiving infrared light from the infrared remote controller, receiving light guide member 13 for receiving ambient light in the environment surrounding the display device, and emitting light guide member 14 for guiding light from the LED for indicating the operation state of the display device. Unit main body 15 can be alternatively configured by at least one of receiving light guide members 12 and 13.

### (Configuration of Reinforcing Frame of Housing)

It is necessary to enhance strength of the housing in order to prevent damage to the display device due to impact or the like during delivery of the display device, because the display device has been reduced in thickness and is provided with a narrow picture-frame. According to the present technique, optical unit 10 is located at the lower section of the display device. It is thus necessary to specially enhance strength at the lower end of the housing.

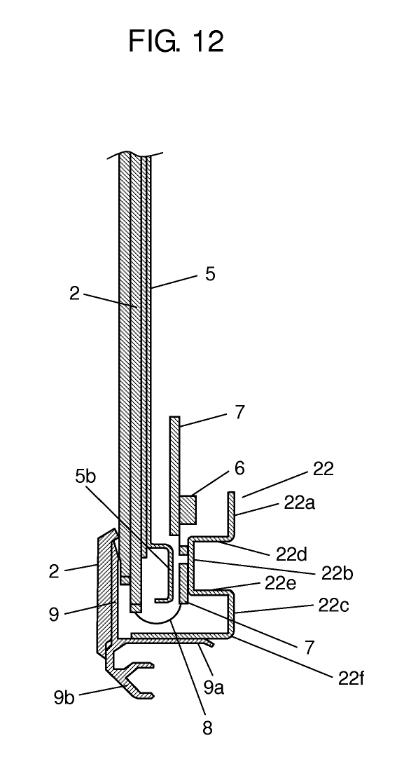

FIG. 12 is a sectional view of an exemplary reinforcing frame in the display device according to the present technique. As shown in FIG. 12, in the present exemplary embodiment, reinforcing frame 22 is attached to the lower section of chassis 5, and metal frame 9, at which optical unit 10 is located, is attached to reinforcing frame 22. Reinforcing frame 22 includes three frame pieces 22a, 22b, and 22c that are parallel to chassis 5, and frame pieces 22d, 22e, and 22f that are provided continuously from and perpendicularly to frame pieces 22a, 22b, and 22c. Reinforcing frame 22 has a crank shape in cross section.

Reinforcing frame 22 thus configured has enhanced mechanical strength in the horizontal and vertical directions. Reinforcing frame 22 attached to the lower section of the display device can enhance mechanical strength at the lower section of the display device. It is thus possible to exert sufficient strength even in the structure including optical unit 10 that is located at the lower section of the housing. This leads to reduction in thickness of the display device and easy adoption of a narrow picture-frame.

The exemplary embodiment has been described above in order to exemplify the technique in the present disclosure. The accompanying drawings and the detailed description have been provided for this purpose.

In order to exemplify the technique, the constituent elements depicted in the accompanying drawings and described in the detailed description may include unessential constituent elements for achieving the object in addition to the constituent elements essential for achieving the object. It should not readily regard the unessential constituent elements as being essential just because these unessential constituent elements are depicted in the accompanying drawings or described in the detailed description.

The exemplary embodiment described above exemplifies the technique in the present disclosure, and thus can be modified, replaced, added, and removed in various manners within the scope of the claims or equivalents thereof.

What is claimed is:

1. A display device comprising:
an optical unit located at a lower section of a housing accommodating a display panel, wherein
the optical unit includes a unit main body having a base and a plurality of light guide members provided integrally to the base, and a case accommodating the unit main body, and
the light guide members of the unit main body include a receiving light guide member that has an incident surface exposed from a front surface of the housing, an emitting surface for emitting light to a light receiving sensor, and a reflective surface provided between the incident surface and the emitting surface; and an emitting light guide member for guiding light from a light emitting diode to the front surface of the housing.

2. The display device according to claim 1, wherein the case has a reflective surface at a position opposite to the reflective surface of the receiving light guide member.

3. The display device according to claim 2, wherein the reflective surface of the case is glossy.

4. The display device according to claim 2, wherein the reflective surface of the case is located substantially parallel to the reflective surface of the receiving light guide member.

5. The display device according to claim 1, wherein the receiving light guide member includes a light guide member for guiding infrared light from an infrared remote controller and a light guide member for guiding ambient light, and the case has a reflective surface at a position opposite to the reflective surface of the light guide member for guiding infrared light.

6. A display device comprising:
an optical unit located at a lower section of a housing accommodating a display panel, wherein
the optical unit includes a unit main body having a receiving light guide member that has an incident surface exposed from a front surface of the housing, an emitting surface for emitting light to a light receiving sensor, and a reflective surface provided between the incident surface and the emitting surface; and a case accommodating the unit main body, and
the case has a reflective surface located at a position opposite to the reflective surface of the receiving light guide member.

7. The display device according to claim 6, wherein the reflective surface of the case is glossy.

8. The display device according to claim 6, wherein the reflective surface of the case is located substantially parallel to the reflective surface of the receiving light guide member.

9. The display device according to claim 6, wherein the receiving light guide member includes a receiving light guide member for guiding infrared light from an infrared remote controller and a receiving light guide member for guiding ambient light, and the case has a reflective surface at a position opposite to the reflective surface of the receiving light guide member for guiding infrared light.

10. The display device according to claim 6, wherein the unit main body of the optical unit has an emitting light guide member for guiding light from a light emitting diode to the front surface of the housing.
